(19) United States
(12) Patent Application Publication
(10) Pub. No.: US 2025/0374902 A1
(43) Pub. Date: Dec. 11, 2025

(54) FISHING LURE WITH ENHANCED ATTACHMENT MECHANISM

(71) Applicant: JYG Pro Fishing LLC, Palm Beach Gardens, FL (US)

(72) Inventors: Jorge Polo Navarro, Jupiter, FL (US); Bryan Casey Brennan, Plantation, FL (US); Kevin Estrada, Loxahatchee, FL (US)

(21) Appl. No.: 19/231,334

(22) Filed: Jun. 6, 2025

Related U.S. Application Data
(60) Provisional application No. 63/656,827, filed on Jun. 6, 2024.

(51) Int. Cl. A01K 85/00; A01K 83/06

(52) U.S. Cl. CPC A01K 85/1831; A01K 83/064; A01K 85/1811

(57) ABSTRACT

The present disclosure relates to a fishing lure assembly that is comprised of a rigid jig head with and a soft cavity with a specially structured cavity. The improved lure facilitates a secure attachment mechanism that allows for interchangeability of the soft bodies of the lure. The unique geometry of the ridged section of the jig head and the corresponding cavity within the soft body of the lure are designed to interlock without damaging the soft body.

This disclosure relates generally to fishing lures, specifically to an improved lure designed to attract fish through durable, interchangeable bodies. The present invention is related to Provisional Patent Application No. 63/656,827 entitled “Fishing Lure with Enhanced Attachment Mechanism”, filed on Jun. 6, 2024, the contents of which are incorporated herein by reference in their entirety.

### TECHNICAL FIELD

### Background of the Invention

Traditional fishing lures have relied on manufacturing and design techniques that have seen little innovation over the past several decades. Despite advancements in material science and manufacturing technology, the basic design and functionality of jig heads and soft plastic lures have remained largely unchanged.

U.S. Pat. No. 5,381,620 discloses a fishing lure utilizing an easily changed tail portion, with the head member being of hard, relatively rigid construction, to the rear of which anyone of a variety of general similar tail members of soft, flexible plastic may be attached in a secure manner. The head member has first and second attachment points thereon, to which a fishing line and a fish hook may be respectively attached, with this member also having an aft portion upon which one or more rearward directed attachment devices are mounted. The attachment device or devices involve at least one rearwardly extending component having an enlarged portion, with each tail member to be used with the head member having a forward most portion in which at least one cavity is disposed. Such cavity is smaller than the enlarged portion of the rearwardly extending component, and position so as to be able to be brought into alignment with the at least one rearwardly protruding component of the head member, and to be received thereon in a tight yet removable manner. The attachment device or devices may be mounted in a comparatively large cavity or recess defined by a rearwardly extending lip or flange disposed around the aft edge of the head member. Into this cavity or recess the forward most portion of the tail member extends in a closely fitting manner, the interfit between the head member and the tail member being such as to prevent the ingress of water during use of the lure.

U.S. Pat. No. 6,718,683 discloses that a hook and torpedo head weight are inserted through a narrow passageway into a cavity shaped to receive the weight of a cast rubber simulation of a live bait. A fish line attaching eyelet on the head protrudes through a precast forward opening in the simulated bait lure. The bait lure is cast of rubberized material in a variety of sizes and shapes depending on the target fish and its environment. The head is molded in a variety of sizes and weights to match the fish component and to account for the versatility for fishing the lure in shallow or deep waters. The bait lure simulates the look, posture, and motion of the live bait.

Presently, what is lacking in the prior art is a fishing lure that leverages modern manufacturing methods to offer improved durability, ease of use, speed of rigging, and versatility.

### SUMMARY

Presently disclosed is an improved fishing lure comprised of a ridged jig head and a soft body with a specially structured cavity.

The improved lure disclosed facilitates a secure attachment mechanism that significantly improves the durability of the lure and allows for interchangeability of the soft bodies of the lure.

The unique geometry of the ridged section of the jig head and the corresponding cavity within the soft body of the lure are designed to interlock without damaging the soft body. The lure assembly is constructed and arranged to enhance the overall performance of the lure, making it a valuable tool for anglers seeking efficiency and reliability in their fishing equipment.

The disclosure is adaptable to a plurality of hook designs, including but not limited to jig heads and weedless hooks, making it a versatile solution for various fishing techniques and target species.

### BRIEF DESCRIPTION OF THE DRAWINGS

The foregoing features may be more fully understood from the following description of the drawings. Various aspects of at least one embodiment are discussed below with reference to the accompanying figures, which are not necessarily drawn to scale, emphasis instead being placed upon illustrating the principles disclosed herein. The drawings aid in explaining and understanding the disclosed technology. Since it is often impractical or impossible to illustrate and describe every possible embodiment, the provided figures depict one or more exemplary embodiments. The figures are incorporated in and constitute a part of this specification but are not intended as a definition of the limits of any embodiment. Accordingly, the figures are not intended to limit the scope of the invention. Like numbers in the figures denote like elements. For purposes of clarity, not every component may be labeled in every figure.

FIG. 1 is an exploded view of one embodiment of the present disclosure;

FIG. 2 is a cross sectional view of one embodiment of the present disclosure;

FIG. 3 is a cross sectional view of one aspect of the present disclosure;

FIG. 4 is a cross sectional view of one aspect of the present disclosure;

FIG. 5 is a cross sectional view of one embodiment of the present disclosure;

FIG. 6 is a cross sectional view of one embodiment of the present disclosure;

FIG. 7 is a cross sectional view of one embodiment of the present disclosure;

FIG. 8 is a cross sectional view of one embodiment of the present disclosure;

FIG. 9 is a cross sectional view of one embodiment of the present disclosure;

FIG. 10 is a cross sectional view of one embodiment of the present disclosure; and

FIG. 11 is a cross sectional view of one embodiment of the present disclosure.

### DETAILED DESCRIPTION

The present disclosure will hereinafter be described with respect to one or more exemplary embodiments, with the understanding that the present disclosure is to be considered an exemplification, and is not intended to limit the invention to the specific embodiments illustrated. It will be understood to one of skill in the art that the apparatus is capable of implementation in other embodiments and of being practiced or carried out in various ways. Also, the phraseology and terminology used herein is for the purpose of description and should not be regarded as limiting. Any references to examples, embodiments, components, elements or acts of the apparatus herein referred to in the singular may also embrace embodiments including a plurality, and any references in plural to any embodiment, component, element, or act herein may also embrace embodiments including only a singularity (or unitary structure). References in the singular or plural form are not intended to limit the presently disclosed apparatus, its components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

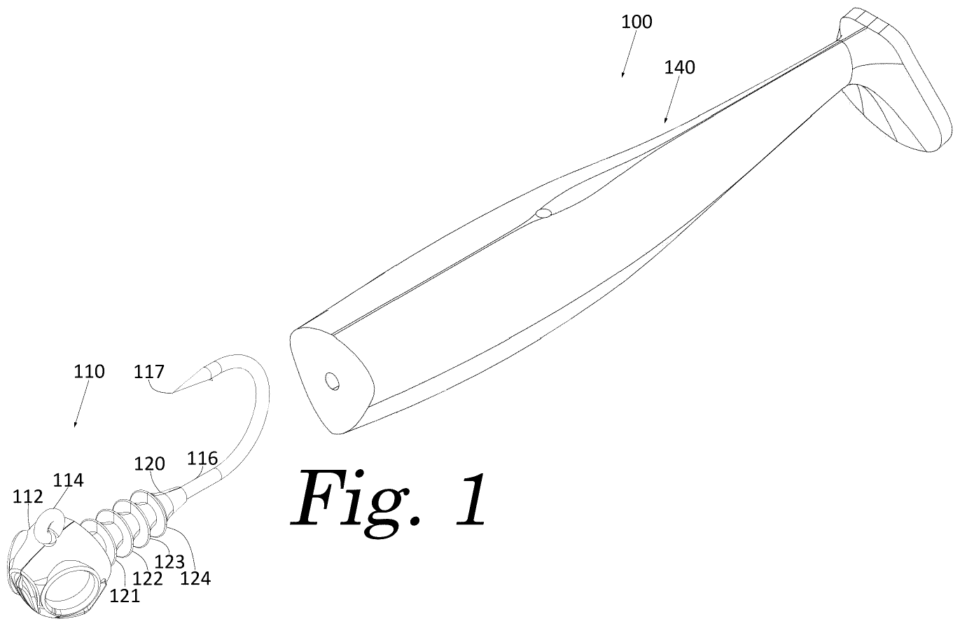

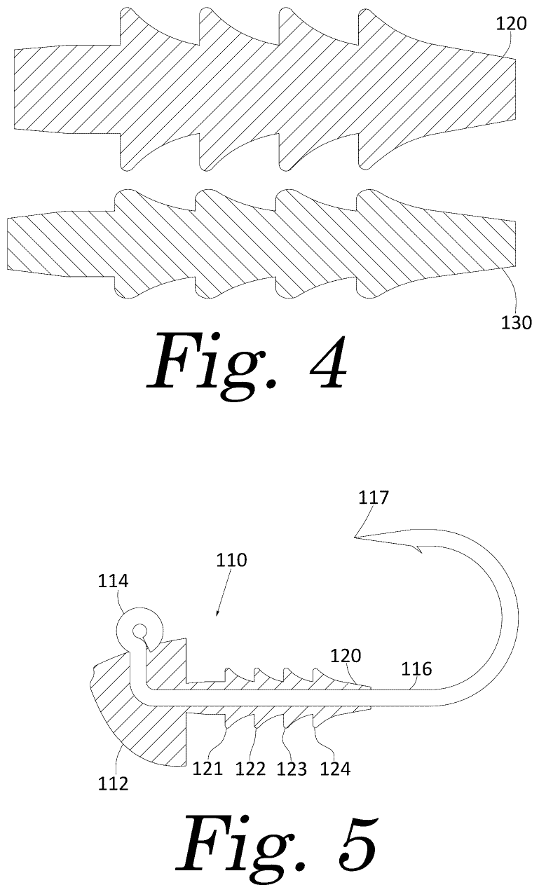

Referring initially to FIGS. 1-4, a fishing lure assembly 100 is disclosed having a jig head assembly 110 and a body assembly 140. The head assembly 110 is comprised of a base 112 having at least one eye 114, a shank 116 and at least one barb 117. In certain embodiments, the head assembly 110 can be integrally formed. An insert assembly 120 is comprised of a plurality of curved conical sections 121, 122, 123, 124. The insert assembly 120 is constructed and arranged to interlock with a cavity assembly 130 in body assembly 140. The cavity assembly 130 has a plurality of curved conical sections 131, 132, 133 and 134.

The insert assembly 120 must be larger than the cavity assembly 130 of the fishing lure. In one non-limiting example, the ratio of diameter of insert assembly 120 to cavity assembly 130 is 2:1. As shown in FIG. 3, another non-limiting example is constructed where the maximum diameter of the insert assembly 120 is 9 mm and the max diameter of the cavity assembly is 6 mm forming a ratio of 1.5:1. It is contemplated that by employing different manufacturing techniques and materials, ratios will be established that correspond to the elasticity of the materials selected.

The insert assembly 120 and the cavity assembly 130 are geometrically similar. For example, the peaks of the insert match with the peaks of the cavity and are constructed and arranged to allow near-constant pressure across the entire surface area where insert assembly 120 and cavity assembly 130 mesh together. The spacing between the peaks of both the insert assembly 120 and cavity assembly 130 are set at a pre-determined distance. The spacing distance between each peak and trough may be variable, but the peaks and troughs of the insert assembly 120 and cavity assembly 130 are constructed and arranged to correspond with each other. The present disclosure can be applied to any method of fishing where a lure body must be attached to a hook or rig system.

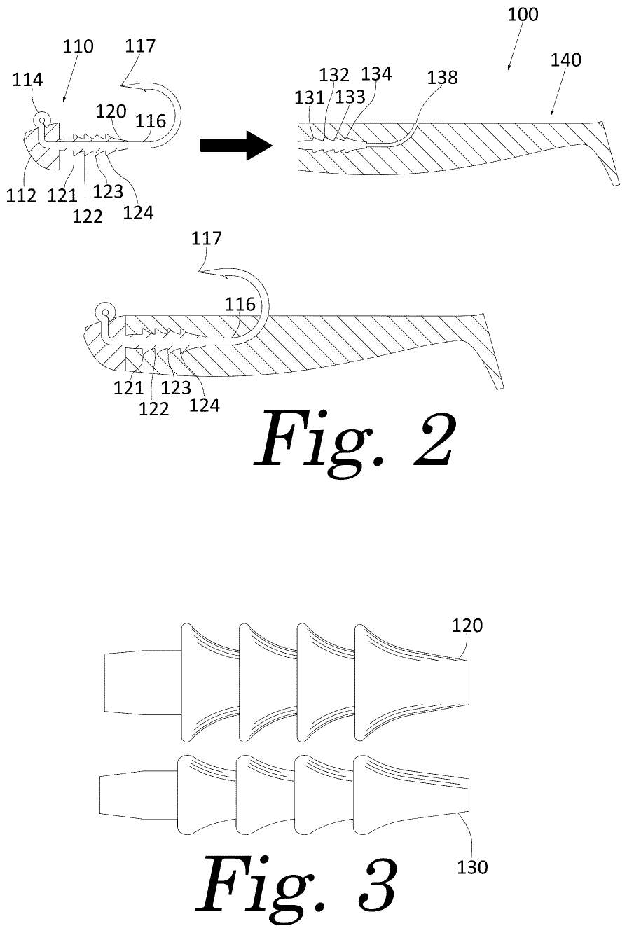

An angler can rig a jig head style lure in the manner disclosed in FIG. 2. In this embodiment, the lure body assembly 140 is comprised of an elastic material. The elastic lure body assembly slides on the shaft 116 of the jig head assembly 110. In one embodiment, lure body 140 has a hook channel 138 to facilitate easier rigging for this method. The user applies a force to push the jig head assembly 110 into the lure body 140. The elastic lure body 140 material having cavity assembly 130 is constructed and arranged to stretch to conform to the geometry of the insert assembly 120 when force is applied by the angler to assemble the lure.

Cross sectional view of head assembly 110 is illustrated in FIG. 2. In one embodiment, the base 112 and the insert assembly 120 are comprised of the same rigid materials including but not limited to, for example, lead, tungsten, resin, plastic, zinc or any other suitable materials or equivalents. In other embodiments, the base 112 and the insert assembly can be comprised of different materials. It is contemplated that multiple combinations of materials could be utilized in any embodiment having an insert assembly and a cavity assembly and would still be within the scope of the present disclosure.

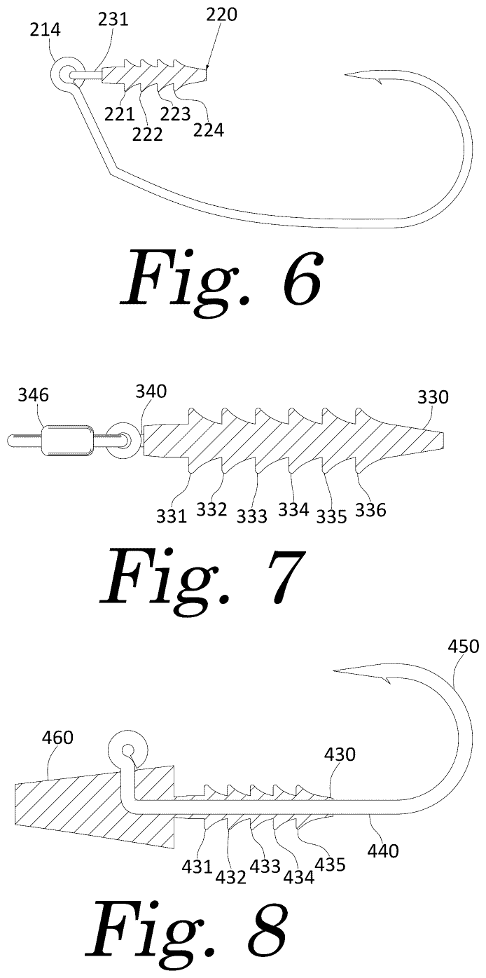

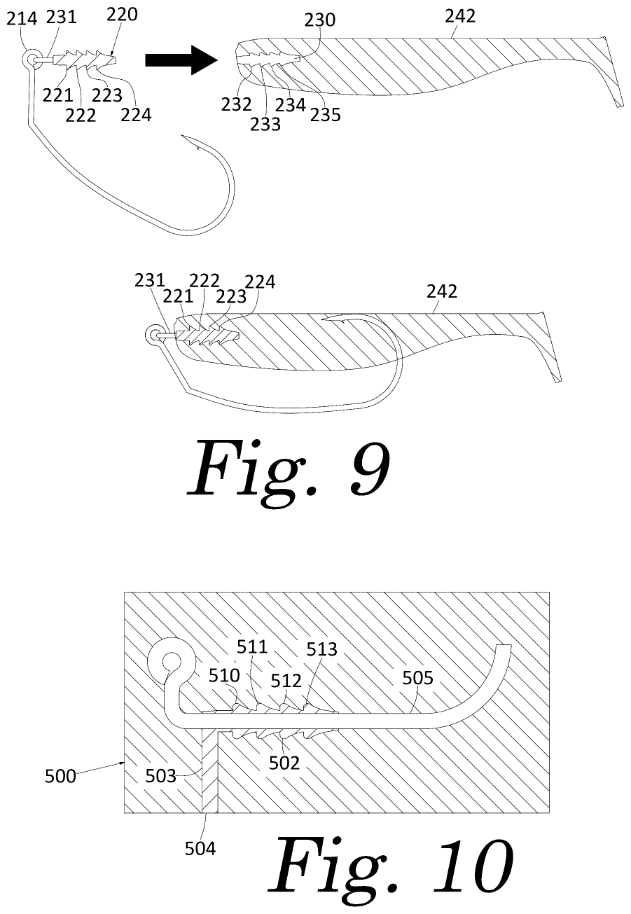

In another embodiment, a weedless swimbait hook style, as shown in FIG. 6, is comprised of an insert assembly 220 having a plurality of curved conical sections 221, 222, 223 and 224 molded onto a shaft 231 and fixedly attached to eye 214. An elastic lure body 242 has a cavity assembly 230 having a plurality of curved conical sections 232, 233, 234 and 235. The insert assembly 220 and the cavity assembly 230 are geometrically similar. An angler would push the cavity assembly 230 over the insert assembly 220 with enough force so that the elastic lure body 242 has stretched to conform to the geometry of the insert 220. The material of the lure body 242 is constructed of a material that allows for the hook to be embedded into the lure body 242 for weedless rigging.

For a teaser or dredge style lure assembly, referring now to FIG. 7, insert assembly 330 having a plurality of conical sections 331, 332, 333, 334, 335 and 336 are molded to a shaft 340 which is fixedly attached to a swivel 346.

It is contemplated that the disclosed insert assemblies can be adapted for any specialty heads. For example, now referring to FIG. 8, disclosed is a head for a squid style lure. The insert assembly 430 having a plurality of curved conical sections 431, 432, 433, 434, and 435 are molded to a shaft 440 of a fishing hook 450 having a head 460 constructed and arranged as a squid style lure.

The unique geometry of the insert and cavity allows for a secure, non-damaging connection between the hook and the body, facilitating easy interchangeability and enhanced durability for maintaining the structural integrity of the lure after multiple attachments and detachments from the hook.

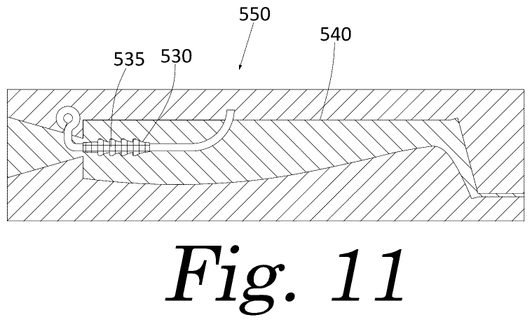

Referring now to FIGS. 10-11, disclosed is a method of manufacture of the fishing lure assembly 100. In one embodiment, the fishing lure assembly 100 is constructed and arranged through injection molding. A mold 500 is comprised of a predetermined volume 502 for positioning of the fishing hook shank 505. The predetermined volume 502 is dimensioned for the desired insert sections, which in this non-limiting example are curved conical sections 510, 511, 512 and 513. Attached to the predetermined volume 502 mold for the insert sections is injection port 504. The desired material for fabricating the insert sections, lead or resin for example, are injected through a port 504 and fills the predetermined volume adhering to the shank 505 thereby creating an insert assembly. The interlocking methods of the present disclosure can however be constructed using 3D printed materials or the desired materials can be adhered to the shank manually.

A lure body 540 is fabricated with a cavity section 530 that is dimensioned by inserting the desired insert assembly 535 into a mold 550 that is the desired shape of the lure body having a predetermined volume. The volume of the mold is filled with the materials selected for the lure body, for example, a soft plastic or polymer. Once, the lure body material has been injected and cured, the insert can be removed and the cavity within the lure body remains.

Having thus described several aspects of at least one disclosed example, it is to be appreciated that various alterations, modifications, and improvements will readily occur to those skilled in the art, without departing from the spirit and scope of the invention as defined by the appended claims. Therefore, the claims are not to be limited to the specific example(s) depicted herein. For example, the features of one example disclosed above can be used with the features of another example. Furthermore, various modifications and rearrangements of the parts may be made without departing from the spirit and scope of the underlying inventive concept. Such alterations, modifications, and improvements are intended to be part of this disclosure and are intended to be within the scope of the examples discussed herein. Thus, the details of these components as set forth in the above-described examples, should not limit the scope of the claims.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A fishing lure assembly comprising:
a head assembly having at least one eye, a shank and a barb including an insert assembly comprised of a plurality of curved conical sections;
a body assembly including a cavity assembly comprised of a plurality of curved conical sections;
wherein, said insert assembly is constructed and arranged to interlock with said cavity assembly.

2. The fishing lure assembly of claim 1, wherein the insert assembly is larger than the cavity assembly.

3. The fishing lure assembly of claim 1, wherein said insert assembly and said cavity assembly are geometrically similar, constructed and arranged to allow near constant pressure across the surface area where said insert assembly and said cavity assembly mesh together.

4. The fishing lure assembly of claim 1, wherein said body assembly is comprised of an elastic material, constructed and arranged to stretch to conform to the geometry of the insert assembly when force is applied to assemble the fishing lure.

5. The fishing lure assembly of claim 1, wherein said head assembly is comprised of a rigid material.

6. The fishing lure assembly of claim 1, wherein said insert assembly is molded to said shaft.

7. The fishing lure assembly of claim 1, wherein said head assembly is integrally formed.

8. A method of manufacturing a fishing lure assembly comprising:
selecting a first mold having a predetermined volume for positioning a fishing hook shank;
attaching an injection port that discharges into the predetermined volume of said first mold;
injecting the predetermined material for fabricating the insert sections whereby the injected material adheres to said fishing hook shank thereby creating an insert assembly;
selecting a second mold body that is the desired shape of the lure body having a predetermined volume,
dimensioning said second mold body by positioning the insert assembly into the second mold;
injecting the second mold with pre-selected materials and allowing said materials to cure for a predetermined amount of time.
